(19) United States
(12) Patent Application Publication
(10) Pub. No.: US 2023/0398844 A1
(43) Pub. Date: Dec. 14, 2023

(54) ROLLING COVER OF PICKUP TRUCK BED

(71) Applicant: HANGZHOU GOLDEN SUN AUTO PARTS CO., LTD., Hangzhou City (CN)

(72) Inventors: Jinqin FU, Hangzhou City (CN); Chenshan LIN, Hangzhou City (CN); Xue'e WANG, Hangzhou City (CN); Xiaohong TANG, Hangzhou City (CN)

(73) Assignee: HANGZHOU GOLDEN SUN AUTO PARTS CO., LTD., Hangzhou City (CN)

(21) Appl. No.: 17/812,130

(22) Filed: Jul. 12, 2022

(30) Foreign Application Priority Data
Jun. 8, 2022 (CN) 202210644472.5

(51) Int. Cl. B60J 7/08; B60J 7/00

(52) U.S. Cl. CPC B60J 7/08; B60J 7/0084

(57) ABSTRACT

A rolling cover of a pickup truck bed is disclosed in this application, and relates to a field of pickup truck accessories. The rolling cover of the pickup truck bed includes two sidebar guide rods and a first bar. Two ends of the first bar are respectively matched with the two sidebar guide rods, and the two sidebar guide rods are in parallel. The rolling cover of the pickup truck bed also includes a soft rolling tarpaulin, one end of which is matched with the first bar and the other end of which is provided with a second bar, and two ends of the second bar are detachably matched with the two sidebar guide rods. The disclosure has following beneficial effects: the soft rolling tarpaulin is adopted and the soft rolling tarpaulin can be fully furled into a tubular shape. When in use, the soft rolling tarpaulin can be fully furled together as long as the two ends of the second bar are disengaged from the sidebar guide rods on both sides.

### CROSS REFERENCE TO RELATED APPLICATION

This Non-provisional application claims priority under 35 U.S.C. § 119(a) to Chinese Patent Application No. 202210644472.5, filed on 8 Jun. 2022, the entire contents of which is hereby incorporated by reference in its entirety.

### TECHNICAL FIELD

The disclosure relates to a field of pickup truck accessories, in particular to a rolling cover of a pickup truck bed.

### BACKGROUND ART

A rolling cover is a common part on a pickup truck bed. A cover of a pickup truck is disclosed in Patent publication CN111645501A, which adopts several cover plates connected by a rotating shaft. Because the cover plates are connected by the rotating shaft and the cover plates can't be folded and rolled up, the cover with this structure can only be furled into a plate shape when it is rolled up, but can't be completely furled into a drum shape.

### SUMMARY

In view of above problems, the present disclosure provides a rolling cover of a pickup truck bed.

Technical schemes adopted in the disclosure are as follows.

A rolling cover of a pickup truck bed includes two sidebar guide rods and a first bar. Two ends of the first bar are respectively matched with the two sidebar guide rods, and the two sidebar guide rods are in parallel. The rolling cover of the pickup truck bed also includes a soft rolling tarpaulin, one end of which is matched with the first bar and the other end of which is provided with a second bar, and two ends of the second bar are detachably matched with the two sidebar guide rods.

In the rolling cover of the pickup truck bed, the soft rolling tarpaulin is adopted, and the soft rolling tarpaulin can be fully furled into a tubular shape. When in use, the soft rolling tarpaulin can be fully furled together as long as the two ends of the second bar are disengaged from the sidebar guide rods on both sides. The soft rolling tarpaulin can be a tarpaulin such as a PVC plastic-coated cloth, a nylon tarpaulin and other tarpaulins, which has waterproof property and is easy to roll and furl.

Specifically, the rolling cover of the pickup truck bed of this disclosure also includes a first inserting block inserted and fixed to the sidebar guide rod, and the first bar is inserted and matched with the first inserting block, the first bar and the two sidebar guide rods are in a same plane, and in order to improve installation stability of the first bar, the first bar is perpendicular to the two sidebar guide rods.

Optionally, an upper surface of the sidebar guide rod is provided with scales, which facilitate accurate positioning and adjusting.

Optionally, the rolling cover of the pickup truck bed of the disclosure further includes a hook and loop fastener, and two parts of the hook and loop fastener are respectively disposed on the sidebar guide rods and the soft rolling tarpaulin. Specifically, the hook and loop fastener include a female part and a male part which can be bonded to each other. A surface of one of two parts is with soft fiber, and a surface of the other of them is with elastic fiber with barbs. The female and male parts are interlocked with each other, and when subjected to a certain lateral force, elastic barbs are straightened, loosened from pile loops and opened, and then restored to an original hook shape. And in this way, it can be repeatedly opened and closed.

The female and male parts of the hook and loop fastener which can be bonded to each other are arranged on the sidebar guide rods and the soft rolling tarpaulin to bond the soft rolling tarpaulin to the sidebar guide rods. With this design, connection strength between the soft rolling tarpaulin and the sidebar guide rods can be improved, so that the soft rolling tarpaulin will not fall off when the pickup truck bumps.

Optionally, the rolling cover of the pickup truck bed of the disclosure further includes a supporting rod. The supporting rod is matched with the soft rolling tarpaulin, and two ends of the supporting rod respectively abut against the two sidebar guide rods.

The supporting rod is arranged on the soft rolling tarpaulin, and serves to support the soft rolling tarpaulin to a certain extent when the soft rolling tarpaulin covers the bed of the pickup truck, so as to prevent the soft rolling tarpaulin from collapsing when in use. The supporting rod is in an arc-shaped structure, that is, a middle of the supporting rod is arched. Because a soft rolling tarpaulin cover is made of soft material and attached to the supporting rod, an upper surface of the soft rolling tarpaulin cover is in a convex structure instead of a flat or concave structure, and it is not easy for rainwater to accumulate on the upper surface of the soft rolling tarpaulin cover. The middle of the supporting rod does not refer to a center position, but any position between the two ends of the supporting rod.

Specifically, in order to facilitate the supporting rod to abut against the sidebar guide rod, the supporting rod is inserted and matched with a clamping hook, and the clamping hook is clamped and matched with the sidebar guide rod. With the clamping hook, stability of matching between the supporting rod and the sidebar guide rod can be improved.

Optionally, the rolling cover of the pickup truck bed of the disclosure further includes a catch assembly, and the catch assembly is arranged on the first bar.

Specifically, the catch assembly is fixed to the first bar with a woven cord, and when the soft rolling tarpaulin is rolled together into a tubular shape, the soft rolling tarpaulin of the tubular shape can be caught together with the catch assembly. The catch assembly can be a buckle for a plug-in fit.

Optionally, the second bar is provided with an arc water guide surface. The arc water guide surface is provided to cause accumulated water on the second bar to flow away in time, so as to ensure that there will be no accumulated water at a joint between the soft rolling tarpaulin and the second bar, and that the accumulated water does not flow into the pickup truck bed along a gap between the second bar and the soft rolling tarpaulin.

Optionally, the sidebar guide rod is provided with a lock aperture, and the second bar is provided with a tongue through a spring, and the tongue is configured for matching with the lock aperture.

When the tongue is matched with the lock aperture, it is means the second bar and the sidebar guide rod are fixed together. When the tongue is disengaged from the lock aperture, the second bar is disengaged from the sidebar guide rod, and the second bar can freely move relative to the sidebar guide rod.

Two ends of the spring are respectively fixed to the tongue and the sidebar guide rod, so as to realize a locking fit or disengagement of the tongue and the lock aperture within an elastic range of the spring. Meanwhile, the spring can also assist in resetting of the tongue.

Optionally, the rolling cover of the pickup truck bed of the disclosure further includes a linkage cable and a handle, and there are two tongues, both ends of the linkage cable are respectively matched with the tongues, and the handle is matched with the linkage cable.

The linkage cable and the handle are provided to link two tongues. By pulling the handle on the linkage cable, the two tongues can be moved together so that the two tongues can be locked with or disengaged from their corresponding lock apertures. Specifically, the linkage cable can be a steel cable or other cables. The second bar is provided with a plurality of guide posts with through holes, and the steel cable passes through the through holes of the guide posts in turn, and the guide posts can guide in a moving direction of the steel cable.

Optionally, the sidebar guide rod is provided with a waterproof sealing strip. Moreover, the sealing strip and the soft rolling tarpaulin are respectively located on different sides of the sidebar guide rod, and the sealing strip is located between the sidebar guide rod and the pickup truck bed, and the sidebar guide rod is required to be fixed with the pickup truck bed, and the sealing strip is arranged below the sidebar guide rod to ensure waterproof performance between the sidebar guide rod and the pickup truck bed.

Optionally, the rolling cover of the pickup truck bed of the disclosure further includes a sidebar clamping block which is provided on the sidebar guide rod, and the sidebar clamping block is clamped and matched with the second bar.

Specifically, the second bar is provided with a second inserting block, and the second inserting block on the second bar is matched with the sidebar clamping block.

Optionally, the sidebar guide rod and/or the second bar is provided with a water guide slope. A water guide slope is arranged on the sidebar guide rod, and with this design, it can be ensured that there will be no water accumulated on the sidebar guide rod, and accumulated water on the sidebar guide rod can flow away smoothly, and does not flow into the pickup truck bed along the gap between the sidebar guide rod and the soft rolling tarpaulin.

The disclosure has beneficial effects as follows: the soft rolling tarpaulin is adopted and the soft rolling tarpaulin can be fully furled into a tubular shape. When in use, the soft rolling tarpaulin can be fully furled together as long as the two ends of the second bar are disengaged from the sidebar guide rods on both sides.

### BRIEF DESCRIPTION OF THE DRAWINGS

FIG. 1 is a schematic diagram of a rolling cover of a pickup truck bed;

FIG. 2 is an enlarged schematic diagram at A in FIG. 1;

FIG. 3 is an enlarged schematic diagram at B in FIG. 1;

FIG. 4 is an enlarged schematic diagram at C in FIG. 1;

FIG. 5 is a schematic diagram of a matching relationship of the sidebar guide rod with the first bar and the second bar;

FIG. 6 is an enlarged schematic diagram at D in FIG. 5; and

FIG. 7 is a schematic diagram of a matching relationship of the second inserting block with the second bar.

Reference numbers in the figures are as follows: 1. Soft rolling Tarpaulin; 2. Sidebar Guide Rod; 201. Water Guide Slope; 3. Bed; 4. Hook and Loop Fastener; 5. Woven Cord; 6. Catch Assembly; 7. Sidebar Clamping Block; 8. Second Inserting Block; 9. Second Bar; 901. Arc Water Guide Surface; 10. Linkage Cable; 11. Tongue; 12. First Bar; 13. Supporting Rod; 14. First Inserting Block; 15. Reinforcing Block; 16. Clamping Hook; 17. Handle; 18. Sealing Strip; 19. Clip; 20. Spring.

### DETAILED DESCRIPTION

The present disclosure will be described in detail with reference to the accompanying drawings.

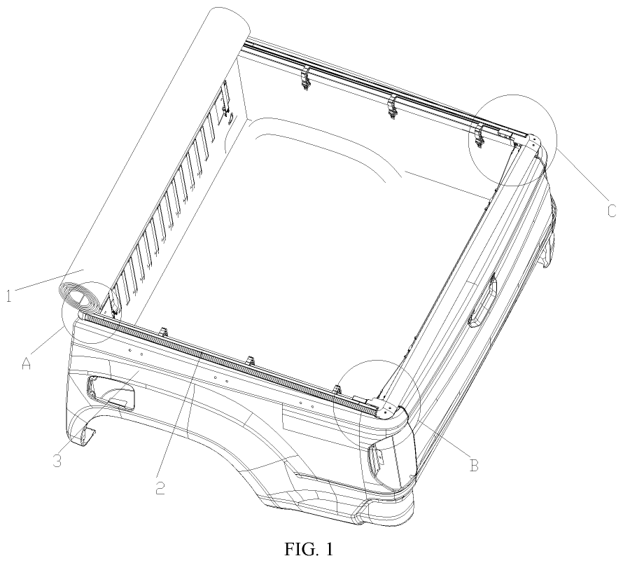

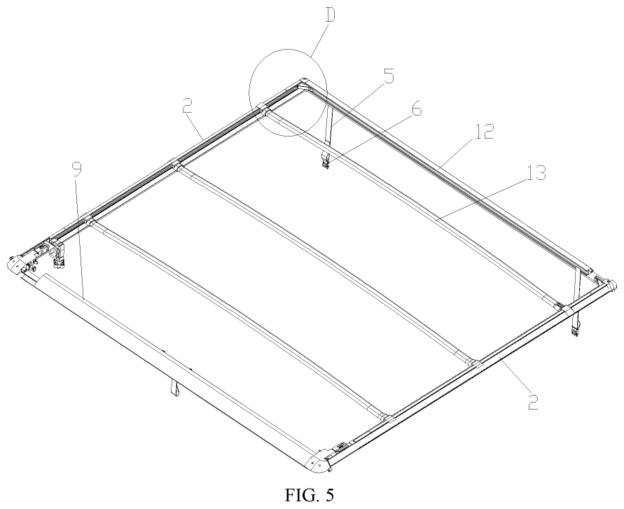

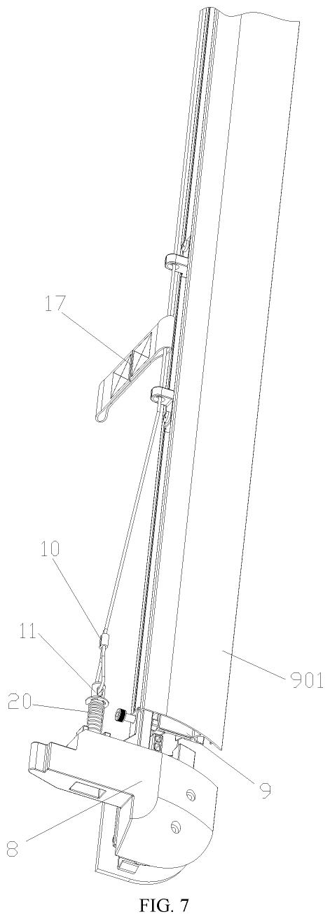

As shown in FIGS. 1, 5 and 7, a rolling cover of the pickup truck bed includes two sidebar guide rods 2 and a first bar 12, and the two sidebar guide rods 2 are respectively arranged on left and right sides of the pickup truck bed. Two ends of the first bar 12 are respectively matched with two sidebar guide rods 2 to form a frame for supporting, and the two sidebar guide rods 2 are in parallel. The rolling cover of the pickup truck bed further includes a soft rolling tarpaulin 1, one side of which is matched with the first bar 12, and the other side of which is provided with a second bar 9, two ends of the second bar 9 are detachably matched with the two sidebar guide rods 2, and the first bar 12, the second bar 9 and the two sidebar guide rods 2 form a square closed frame, so that the soft rolling tarpaulin 1 can be supported.

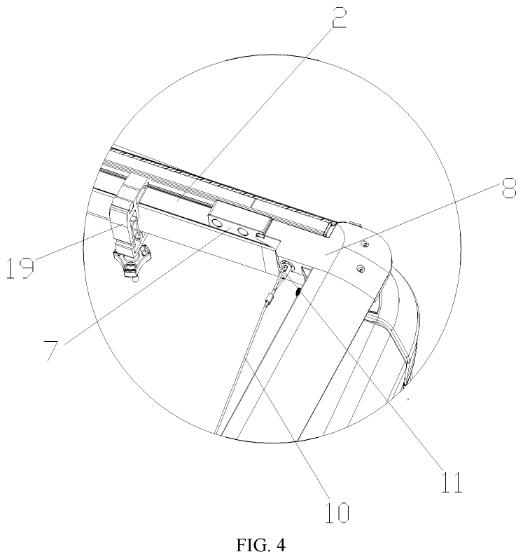

In the rolling cover of the pickup truck bed of this embodiment, the soft rolling tarpaulin 1 is adopted. Compared with an existing hard cover plate, the soft rolling tarpaulin 1 can be fully furled into a tubular shape. When in use, the soft rolling tarpaulin 1 can be rolled up along the second bar 9 and fully furled together as soon as the two ends of the second bar 9 are disengaged from the sidebar guide rods 2 on both sides. As shown in FIG. 4, the sidebar guide rod 2 is provided with a clip 19, which can clamp the sidebar guide rod 2 on the pickup truck bed. The clip 19 is a split structure, which is connected through a screw, and is locked up along the screw with a knob nut.

Specifically, the rolling cover of the pickup truck bed of this disclosure also includes a first inserting block 14 inserted and fixed to the sidebar guide rod 2, and the first bar 12 is inserted and matched with the first inserting block 14, the first bar 12 and the two sidebar guide rods 2 are in a same plane, and in order to improve installation stability of the first bar 12, the two sidebar guide rods 2 are perpendicular to the first bar 12, that is, included angles formed by the two sidebar guide rods 2 and the first bar 12 are both 90 degrees.

Specifically, In the rolling cover of the pickup truck bed of this embodiment, in order to improve installation stability between the first bar 12 and the sidebar guide rod, a triangular reinforcing block 15 is further provided between the first bar 12 and the sidebar guide rod 2, and the reinforcing block 15 is fixed with the first bar 12 and the sidebar guide rod by screws. The reinforcing block 15 is a right-angled triangle in shape, and two right-angled sides of the reinforcing block 15 are tightly attached to the first bar 12 and the sidebar guide rod 2, respectively, forming a stable triangular supporting structure.

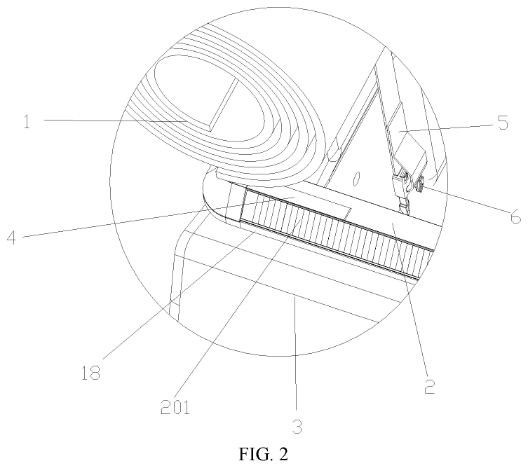

As shown in FIGS. 1 and 2, the rolling cover of the pickup truck bed of the disclosure further includes a hook and loop fastener 4, and two parts of the hook and loop fastener 4 are respectively disposed on the sidebar guide rods 2 and the soft rolling tarpaulin 1.

Female and male parts of the hook and loop fastener 4 which can be bonded to each other are arranged on the sidebar guide rods 2 and the soft rolling tarpaulin to bond the soft rolling tarpaulin to the sidebar guide rods 2. With this design, connection strength between the soft rolling tarpaulin and the sidebar guide rods 2 can be improved, so that the soft rolling tarpaulin 1 will not fall off when the pickup truck bumps.

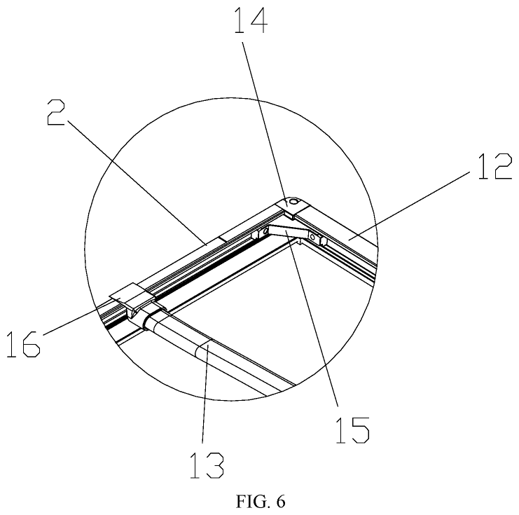

As shown in FIGS. 1, 5 and 6, the rolling cover of the pickup truck bed of the disclosure further includes a supporting rod 13. The supporting rod 13 is matched with the soft rolling tarpaulin, and two ends of the supporting rod 13 respectively abut against the two sidebar guide rods 2.

The supporting rod 13 is arranged on the soft rolling tarpaulin, and serves to support the soft rolling tarpaulin to a certain extent when the soft rolling tarpaulin covers the bed 3 of the pickup truck, so as to prevent the soft rolling tarpaulin from collapsing when in use.

Specifically, in order to facilitate the supporting rod 13 to abut against the sidebar guide rod 2, the supporting rod 13 is inserted and matched with a clamping hook 16, and the clamping hook 16 is clamped and matched with the sidebar guide rod 2. With the clamping hook 16, stability of matching between the supporting rod 13 and the sidebar guide rod 2 can be improved.

As shown in FIGS. 1, 2, 3 and 4, the rolling cover of the pickup truck bed of the disclosure further includes a catch assembly 6, and the catch assembly 6 is arranged on the first bar 12.

Specifically, the catch assembly 6 is fixed to the first bar 12 with a woven cord 5, and when the soft rolling tarpaulin 1 is rolled together into a tubular shape, the soft rolling tarpaulin 1 of the tubular shape can be caught together with the catch assembly 6. Specifically, the catch assembly 6 can be a buckle.

As shown in FIGS. 2, 3, 4 and 7, the second bar 9 is provided with an arc water guide surface 901. The arc water guide surface 901 is provided to cause accumulated water on the second bar 9 to flow away in time, so as to ensure that there will be no accumulated water at a joint between the soft rolling tarpaulin and the second bar 9, and that the accumulated water does not flow into the pickup truck bed through a gap between the second bar 9 and the soft rolling tarpaulin 1.

As shown in FIGS. 2, 3 and 4, the sidebar guide rod 2 is provided with a lock aperture (not shown in the figure, the lock aperture is a hole in the sidebar guide rod), and the second bar 9 is provided with a tongue 11 through a spring 20, and the tongue 11 is configured for matching with the lock aperture.

When the tongue 11 is matched and locked with the lock aperture, it is means the second bar 9 and the sidebar guide rod 2 are fixed together. When the tongue is disengaged from the lock aperture, the second bar 9 is disengaged from the sidebar guide rod 2, and the second bar 9 can freely move relative to the sidebar guide rod 2.

Two ends of the spring 20 are respectively fixed to the tongue 11 and the sidebar guide rod 2.

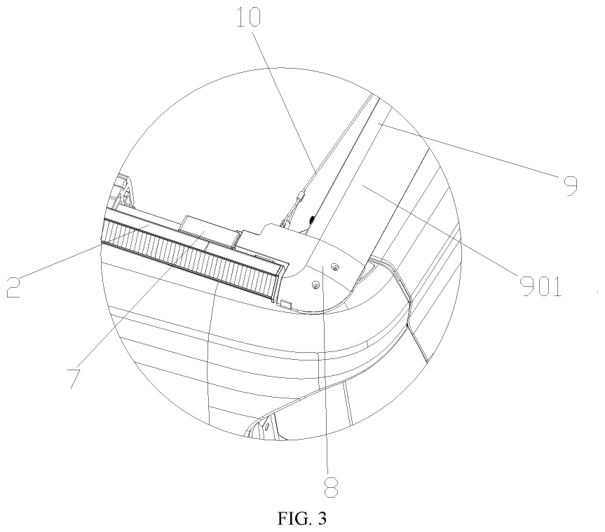

As shown in FIGS. 3, 4 and 7, the rolling cover of the pickup truck bed of the disclosure further includes a linkage cable 10 and a handle 17, and there are two tongues 11, both ends of the linkage cable are respectively matched with the tongues 11, and the handle 17 is matched with the linkage cable 10.

The linkage cable 10 and the handle are provided to link two tongues 11. By pulling the handle on the linkage cable, the two tongues 11 can be retracted, so that the tongues 11 can be disengaged from the lock aperture, and the second bar 9 can move freely. When the second bar 9 is installed on the sidebar guide rod 2, the two tongues 11 are aligned with their corresponding lock apertures, the two tongues 11 is pressed (an external force is applied to the two tongues 11), and the tongues 11 are clamped into the lock apertures under an elastic force of the spring 20. Specifically, the linkage cable 10 is a steel cable, which has a large bearing safety factor and is safe and reliable to use.

As shown in FIG. 2, a sealing strip 18 is provided below the sidebar guide rod 2, and the soft rolling tarpaulin 1 is located above the sidebar guide rod 2. The sidebar guide rod 2 is required to be fixed with the pickup truck bed 3, and thus the sealing strip 18 is arranged below the sidebar guide rod 2 to ensure waterproof performance between the sidebar guide rod 2 and the pickup truck bed 3. The soft rolling tarpaulin 1 is located above the sidebar guide rod 2, which facilitates disassembly and assembly of the soft rolling tarpaulin 1.

As shown in FIGS. 3 and 4, the rolling cover of the pickup truck bed of the disclosure further includes a sidebar clamping block 7 which is arranged on the sidebar guide rod 2, and the sidebar clamping block 7 is clamped and matched with the second bar 9.

Specifically, the second bar 9 is provided with a second inserting block 8, and the second inserting block 8 on the second bar 9 is matched with the sidebar clamping block 7.

As shown in FIGS. 2 and 3, the sidebar guide rod 2 is provided with a water guide slope 201.

The water guide slope 201 is arranged on the sidebar guide rod 2, and with this design, it can be ensured that there will be no water accumulated on the sidebar guide rod 2, and accumulated water on the sidebar guide rod 2 can flow away smoothly.

The above is only preferred embodiments of the present disclosure, which does not limit a protection scope of the present disclosure. Any equivalent transformation made with content of the specification of the present disclosure, which is directly or indirectly applied to other related technical fields, is included within the scope of the disclosure.

What is claimed is:

1. A rolling cover of a pickup truck bed comprising two sidebar guide rods, a first inserting block and a first bar, two ends of the first bar being respectively matched with the two sidebar guide rods, and the two sidebar guide rods being in parallel, wherein the rolling cover of the pickup truck bed further comprises a soft rolling tarpaulin, one end of which is matched with the first bar and the other end of which is provided with a second bar, and two ends of the second bar are detachably matched with the two sidebar guide rods; a reinforcing block is provided between the sidebar guide rods and the first bar.

2. The rolling cover of the pickup truck bed according to claim 1, further comprising a hook and loop fastener, and two parts of the hook and loop fastener are respectively disposed on the sidebar guide rods and the soft rolling tarpaulin.

3. The rolling cover of the pickup truck bed according to claim 1, further comprising a supporting rod, wherein the supporting rod is matched with the soft rolling tarpaulin, and the supporting rod is provided with a clamping hook, and the clamping hook is clamped and matched with the sidebar guide rod.

4. The rolling cover of the pickup truck bed according to claim 1, further comprising a catch assembly, wherein the catch assembly is arranged on the first bar.

5. The rolling cover of the pickup truck bed according to claim 1, wherein the second bar is provided with an arc water guide surface.

6. The rolling cover of the pickup truck bed according to claim 1, wherein the sidebar guide rod is provided with a lock aperture, and the second bar is provided with a tongue through a spring, the tongue being configured for matching with the lock aperture.

7. The rolling cover of the pickup truck bed according to claim 6, further comprising a linkage cable and a handle, and two tongues, wherein both ends of the linkage cable are respectively matched with the tongues, and the handle is matched with the linkage cable.

8. The rolling cover of the pickup truck bed according to claim 1, wherein the sidebar guide rod is provided with a waterproof sealing strip.

9. The rolling cover of the pickup truck bed according to claim 1, further comprising a sidebar clamping block which is arranged on the sidebar guide rod, the sidebar clamping block being clamped and matched with the second bar.

10. The rolling cover of the pickup truck bed according to claim 1, wherein the sidebar guide rod is provided with a water guide slope.
